(19) United States
(12) Patent Application Publication
(10) Pub. No.: US 2013/0125833 A1
(43) Pub. Date: May 23, 2013

(54) ANIMAL RESTRAINT SYSTEM

(71) Applicant: Kevin McCoy, Denham Springs, LA (US)

(72) Inventor: Kevin McCoy, Denham Springs, LA (US)

(21) Appl. No.: 13/677,608

(22) Filed: Nov. 15, 2012

Related U.S. Application Data
(60) Provisional application No. 61/561,357, filed on Nov. 18, 2011.

(51) Int. Cl. A01K 27/00

(52) U.S. Cl. CPC A01K 27/003; A01K 27/00
USPC 119/795; 119/769

(57) ABSTRACT

An animal restraint system. The animal restraint system includes a club and a locking device within the club. The locking device includes a first movable object and a second movable object. The locking device also includes a housing. The housing defines at least a cavity, a first bore for receiving the first movable object, and a second bore which opens into the cavity and intersects with the first bore, and in which the second movable object is at least partially disposed. Upon movement of the first movable object into a locking position within the first bore, the second movable object is caused to be moved to a position securing an external object within the cavity.

### CROSS-REFERENCE TO RELATED APPLICATIONS

This application claims the benefit of and priority to U.S. Provisional Patent Application Ser. No. 61/561,357 filed on Nov. 18, 2012, which application is incorporated herein by reference in its entirety.

This application incorporates U.S. Pat. No. 6,415,476, issued on Jul. 9, 2002, and entitled, “LOCKING DEVICES AND RELATED METHODS OF LOCKING”, herein by reference in its entirety.

### BACKGROUND OF THE INVENTION

A baton or club is a common weapon carried by the police. It is an effective weapon allowing the carrier to defend himself/herself or use necessary force. In particular, the baton can allow force to be used without using deadly force. However, carrying the baton can lead to a number of drawbacks.

In particular, the carrier might have other items that he/she is carrying. For example, a police officer may be carrying a gun, mace, handcuffs, a radio, a phone, ticket pads or any other number of items. In addition, the police officer may be attempting to control a police dog or other item. This may mean that a police officer is forced to decide which item to have at hand in a particular situation. If the officer is wrong, the consequences may be fatal.

Accordingly, there is a need in the art that allows a baton carrier to attach the baton to an external device, such as a leash or collar controlling an animal.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an animal restraint system. The animal restraint system includes a club and a locking device within the club. The locking device includes a first movable object and a second movable object. The locking device also includes a housing. The housing defines at least a cavity, a first bore for receiving the first movable object, and a second bore which opens into the cavity and intersects with the first bore, and in which the second movable object is at least partially disposed. Upon movement of the first movable object into a locking position within the first bore, the second movable object is caused to be moved to a position securing an external object within the cavity.

Another example embodiment includes an animal restraint system. The animal restraint system includes a club including a handle and a locking device within the club. The locking device includes a first movable object and a second movable object. The locking device also includes a housing. The housing defines at least a cavity, a first bore for receiving the first movable object, and a second bore which opens into the cavity and in which the second movable object is at least partially disposed. Upon movement of the first movable object into a locking position within the first bore, the second movable object is caused to be moved to a position in proximity or in contact with an abutting surface within the cavity.

Another example embodiment includes an animal restraint system. The animal restraint system includes a club including a handle and a trigger within the handle. The animal restraint system also includes a locking device within the club. The locking device includes a first elongated member and a second elongated member. The locking device also includes a first ball bearing and a second ball bearing. The locking device further includes a plate connecting the first elongated member and the second elongated member. The locking device additionally includes a shaft connecting the trigger to the plate and a housing. The housing defines at least a cavity, a first bore for receiving the first elongated member and a second bore for receiving the second elongated member. The housing also defines a third bore which opens into the cavity and intersects with the first bore, and in which the first ball bearing is at least partially disposed. The housing further defines a fourth bore which opens into the cavity and intersects with the second bore, and in which the second ball bearing is at least partially disposed. The locking device moreover includes biasing means for biasing the first elongated member towards engagement with the first bore and the second elongated member towards engagement with the second bore. Upon movement of the first elongated member into a locking position within the first bore, the first ball bearing is caused to be moved to a position in proximity or in contact with a first abutting surface within the cavity. Upon movement of the second elongated member into a locking position within the first bore, the second ball bearing is caused to be moved to a position in proximity or in contact with a second abutting surface within the cavity.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of an animal restraint system; and

FIG. 2 illustrates a cross-section of the animal restraint system of FIG. 1;

FIG. 3A is a cross-sectional view of the locking device;

FIG. 3B is a cross-sectional view of the locking device in an unlocked position;

FIG. 3C is a cross-sectional view of the locking device taken along lines 3-3 of FIG. 3B;

FIG. 4A illustrates the alternative movable object in a first position; and

FIG. 4B illustrates the alternative movable object in a second position.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

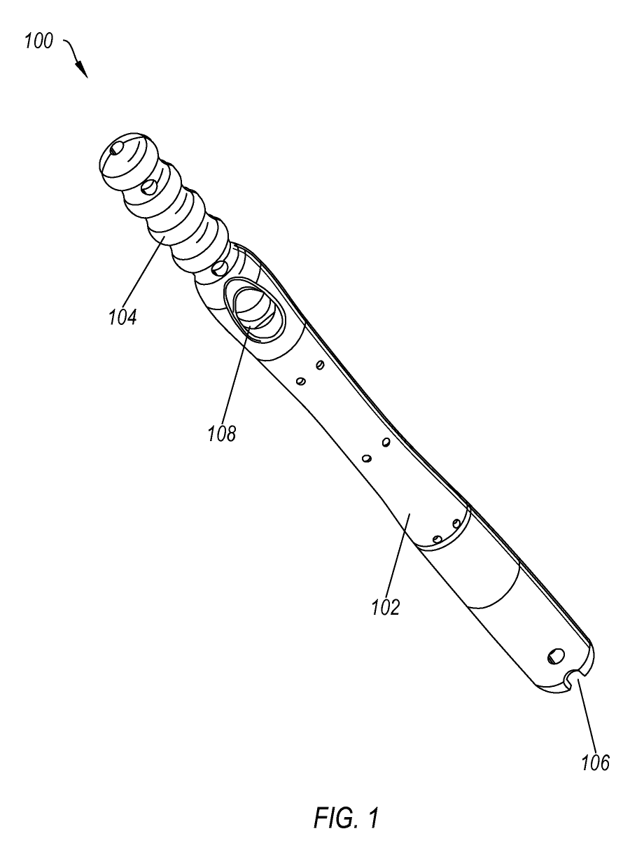

FIG. 1 illustrates an example of an animal restraint system 100. In at least one implementation, the animal restraint system 100 can include a combination of a club 102 and a locking apparatus. For example, the locking apparatus can be embedded within the club 102, such as a rod or baton. E.g., the club 102 can be a police baton. The locking apparatus can attach to an external device, such as a collar or leash, as described below. Additionally or alternatively, the club 102 can be used as a self-defense club when not attached to the external device.

FIG. 1 shows that the animal restraint system 100 can include a handle 104. In at least one implementation, the handle 104 can allow a user to hold the animal restraint system 100. For example, if using the system 100 as a club, the handle 104 can allow the user to grip the rod. Additionally or alternatively, the handle 104 can allow the user to control the external device attached to the animal restraint system 100.

FIG. 1 also shows that the animal restraint system 100 can include a locking device 106. In at least one implementation, the locking device 106 can be configured to allow the animal restraint system 100 to connect to an external device. For example, the locking device 106 can be configured to attach to a collar or leash. I.e., the animal restraint system 100 can allow the user to control an animal, such as a dog, and release the leash or collar of the animal when desired.

FIG. 1 further shows that the animal restraint system 100 can include a trigger 108. In at least one implementation, the trigger 108 can allow the user to release the locking device 106 when desired. In particular, by pulling or activating the trigger 108 the user can cause the locking device 106 to open, thus releasing or receiving the external device.

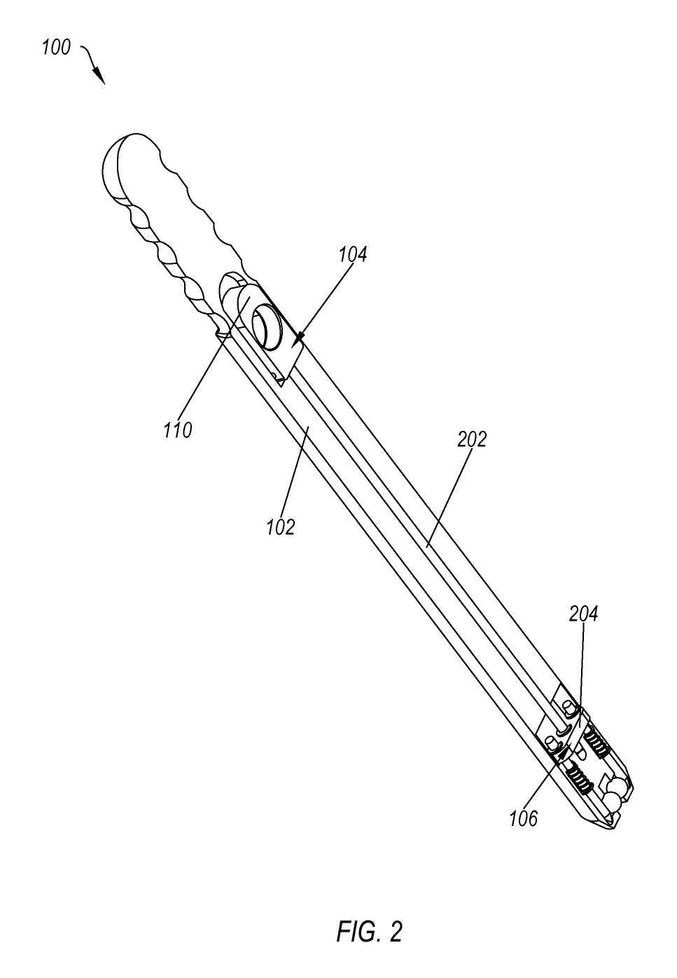

FIG. 2 illustrates a cross-section of the animal restraint system 100 of FIG. 1. In at least one implementation, the locking device 106 can be located partially or completely within a rod. I.e., the external surface of the animal restraint system 100 can be used as a club 102, while the interior includes a locking device 106 which can be used to attach or release an external device.

FIG. 2 shows that the animal restraint system 100 can include a shaft 202. In at least one implementation, the shaft 202 is connected to the trigger 108. I.e., as the trigger 108 is pulled, it causes the shaft 202 to move along its main axis. That is, movement of the trigger 108 results in movement of the shaft and vice versa.

FIG. 2 also shows that the animal restraint system 100 can include a plate 204. In at least one implementation, the plate 204 can be connected to the shaft 202. I.e., motion in the trigger 108 can be transferred via the shaft 202 to the plate 204. One of skill in the art will appreciate that the magnitude of the movement of the trigger 108, shaft 202 and plate 204 need not be equal. I.e., the plate 204 may move a greater or lesser distance relative to the trigger 108.

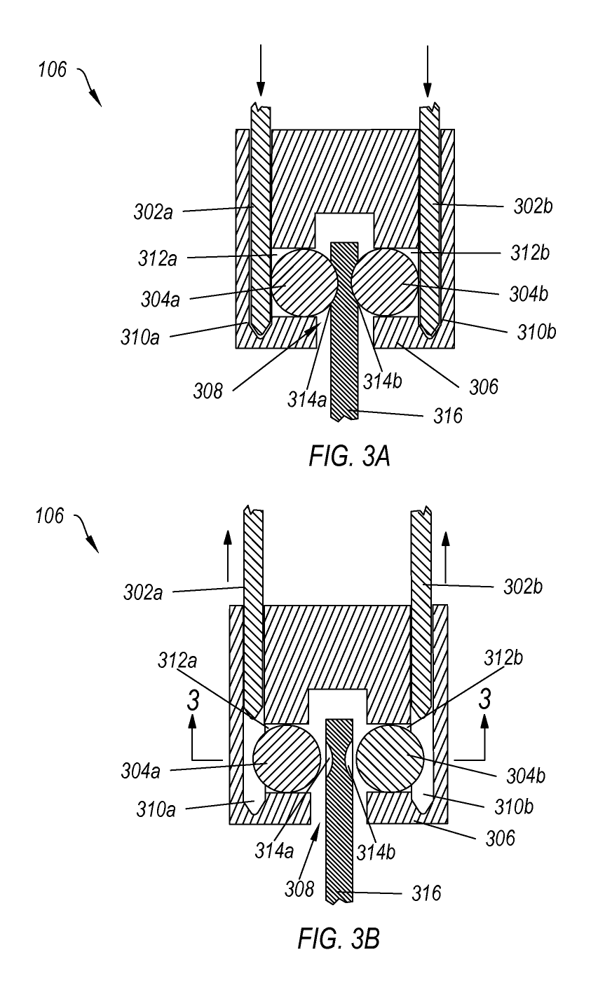

FIGS. 3A, 3B and 3C illustrate an example of a locking device 106. FIG. 3A is a cross-sectional view of the locking device 106; FIG. 3B is a cross-sectional view of the locking device 106 in an unlocked position; and FIG. 3C is a cross-sectional view of the locking device 106 taken along lines 3-3 of FIG. 3B. The locking device 106 can releasably attach to an external device. The external device can include an apparatus to control an animal, such as a leash or collar. I.e., the external device can allow a user to directly control an animal using the animal restraint system 100.

The locking device 106 depicted is comprised of two movable objects in the form of elongated members 302a and 302b (collectively “elongated members 302”), such as pins, two movable objects 304a and 304b (collectively “movable objects 304”), such as a sphere (e.g., ball bearings), and a housing 306. Housing 306 further defines a cavity 308, two first bores 310a and 310b (collectively “first bores 310”) for receiving respectively elongated members 302a and 302b, and two second bores 312a and 312b (collectively “second bores 312”) which open into cavity 308 and intersect respectively with bores 310 in substantially perpendicular fashion. As can be seen from the figures, movable objects 304 are at least partially disposed respectively within bores 312. When elongated members 302 are received respectively by bores 310, movable objects 304 are moved to a position which is either proximate to or in contact with two respective abutting surfaces 314a and 314b (collectively “abutting surfaces 314”) in cavity 308. Each abutting surface 314a and 314b in the preferred embodiment depicted defines an indentation conforming to the shape of at least a portion of one of movable objects 304, surface 314a and 314b itself being defined by a dimpled flange 316.

FIG. 3A illustrates, with arrows, the direction in which elongated members 302 are moved to be placed in fully engaged position, movable objects 304 each being in contact with a corresponding abutting surface 314a and 314b, while FIG. 3B illustrates, with arrows, the direction in which elongated members 302 are moved to be in fully disengaged position to permit removal of flange 316 from cavity 308. In this way, flange 316 is locked to housing 306 when elongated members 302 are inserted into bores 310 so as to move movable objects 304 into locking proximity or contact with flange 316. As movable objects 304 come into contact with and are received by their respective abutting and form-fitting surfaces, they interlock so as to inhibit removal of flange 316 from cavity 308.

It should be appreciated that, in alternative embodiments, the abutting surface towards which the movable objects 304 move may alternatively be (1) one or more apertures in the flange 316 being locked, the apertures being of sufficient diameter to receive at least a portion of the movable objects 304, or (2) the surface of an opposing movable object 304a, or (3) merely a surface of the cavity wall which defines cavity 308. These variations in the device depicted are possible in view of the fact that only one bore 310a for receiving the elongate movable pin and one bore 312a for receiving at least a portion of the movable object 304a are required to provide either a locking engagement or barrier to prevent removal of items from within the cavity 308, while a plurality of both types of bores 310 (and their associated pins and movable objects 304) is contemplated by and is within the scope of this invention. One of skill in the art will appreciate that while dimpled flange 316 of FIGS. 3A, 3B and 3C defines bilateral dimples, the flange 316 may define only one dimple or more than two dimples.

Moreover, in other alternative embodiments, no flange 316 is required. Rather, an item to be locked in place, such as, e.g., a ring or cord, such as a leash, may be placed in locked relationship with housing 306 simply by placing the item in cavity 308 and engaging elongated members 302 with bores 310 to bring movable objects 304 towards one another sufficiently to inhibit removal of the item from cavity 308. As with flange 316 in FIGS. 3A, 3B and 3C, the item is merely the object being locked into place, and the character of that object is no limitation of the present invention, so long as removal of the flange 316, ring or other object from the housing cavity is inhibited when the device is in locked position.

One of skill in the art will appreciate that each movable object 304a can be supplemented with a two-part fitting comprised of two cylindrical, hollowed out fitting halves which combine to surround the respective movable object 304a and provide a larger surface area for contact between the movable object 304a and the housing 306 surface(s) which define the respective second bores 312. Another alternative embodiment may employ a second moveable object 304b having a shape which is not completely spherical but which is consonant with the shape of the movable object 304a/fitting combination. In either case, it is believed that the increased surface area, if necessary, provides even more useful life to this second movable object 304b component of the locking device 106.

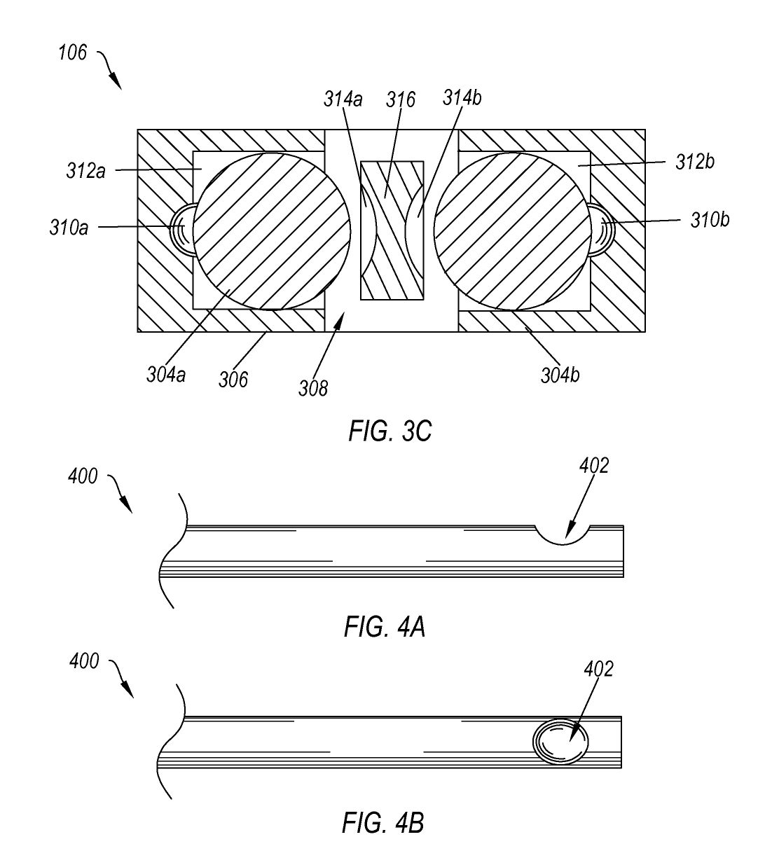

FIGS. 4A and 4B illustrate an alternative first elongated member 400. FIG. 4A illustrates the alternative elongated member 400 in a first position; and FIG. 4B illustrates the alternative elongated member 400 in a second position. Elongated member 400 is characterized in that it defines a recess 402 which accommodates the second movable object in the device, namely one of movable objects 304 of FIGS. 3A-3C. When elongated member 400 is engaged with or disengaged from first bore 310 in housing 306 (which are seen, e.g., in FIG. 3A), one of movable objects 304 (seen in FIG. 3A, for example) may be received by recess 402 which brings the movable object 304a out of proximity to an abutting surface. When elongated member 400 is sufficiently moved, either through rotation of elongated member 400 about the longitudinal axis of elongated member 400 or through sliding engagement or disengagement of elongated member 400 with first bore 310 in substantially parallel fashion to the longitudinal axis of elongated member 400, elongated member 400 of preferred devices of this invention may no longer be received by recess 402, so that elongated member 400 is placed back in proximity or contact with the abutting surface within the housing cavity through its contact with a non-recessed outer surface 402 of elongated member 400.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An animal restraint system, the animal restraint system comprising:
a club; and
a locking device within the club, the locking device including:
a first movable object;
a second movable object; and
a housing, wherein the housing defines at least:
a cavity;
a first bore for receiving the first movable object; and
a second bore which opens into the cavity and intersects with the first bore, and in which the second movable object is at least partially disposed;
whereby upon movement of the first movable object into a locking position within the first bore, the second movable object is caused to be moved to a position securing an external object within the cavity.

2. The animal restraint system of claim 1 wherein the first movable object includes an elongated member.

3. The animal restraint system of claim 2 wherein the elongated member includes a pin.

4. The animal restraint system of claim 1 wherein the second movable object is spherical.

5. The animal restraint system of claim 4 wherein the second movable object includes a ball bearing.

6. The animal restraint system of claim 1 wherein the external object includes a leash.

7. An animal restraint system, the animal restraint system comprising:
a club including a handle; and
a locking device within the club, the locking device including:
a first movable object;
a second movable object; and
a housing, wherein the housing defines at least:
a cavity;
a first bore for receiving the first movable object; and
a second bore which opens into the cavity and intersects with the first bore, and in which the second movable object is at least partially disposed;
whereby upon movement of the first movable object into a locking position within the first bore, the second movable object is caused to be moved to a position in proximity or in contact with an abutting surface within the cavity.

8. The animal restraint system of claim 7 wherein the abutting surface defines an indentation conforming to the shape of at least a portion of the second movable object.

9. The animal restraint system of claim 7 wherein the abutting surface is formed by the housing.

10. The animal restraint system of claim 7 wherein the second movable object is moved to a position in contact with the abutting surface.

11. The animal restraint system of claim 7 further comprising biasing means for biasing the first movable object towards engagement with the first bore.

12. The animal restraint system of claim 11 wherein the biasing means includes mechanical means for biasing the first movable object towards engagement with the first bore.

13. The animal restraint system of claim 11 wherein the mechanical means includes a spring.

14. The animal restraint system of claim 7 further comprising a trigger:
attached to the first movable object; and
configured to cause the first movable object to disengage the first bore.

15. The animal restraint system of claim 14 wherein the trigger is connected to the first movable object by a plate.

16. The animal restraint system of claim 15 wherein the trigger is connected to the first movable object by a shaft configured to transfer movement of the trigger to the plate.

17. The animal restraint system of claim 7 wherein:
the first movable object includes an elongated member;
the second movable object is spherical; and
the first movable object is inserted into the first bore by movement of the first movable object in a direction substantially parallel to its imaginary longitudinal axis so as to be placed in locking position.

18. The animal restraint system of claim 7 wherein:
the first movable object includes an elongated member;
the second movable objects is spherical; and
the first movable objects is rotated about its imaginary longitudinal axis within the first bore so as to be placed in locking position.

19. An animal restraint system, the animal restraint system comprising:
a club including a handle;
a trigger within the handle; and
a locking device within the club, the locking device including:
a first elongated member;
a second elongated member;
a first ball bearing;
a second ball bearing
a plate connecting the first elongated member and the second elongated member;
a shaft connecting the trigger to the plate;
a housing, wherein the housing defines at least:
a cavity;
a first bore for receiving the first elongated member;
a second bore for receiving the second elongated member;
a third bore which opens into the cavity and intersects with the first bore, and in which the first ball bearing is at least partially disposed; and
a fourth bore which opens into the cavity and intersects with the second bore, and in which the second ball bearing is at least partially disposed; and
biasing means for biasing:
the first elongated member towards engagement with the first bore; and
the second elongated member towards engagement with the second bore;
wherein upon movement of the first elongated member into a locking position within the first bore, the first ball bearing is caused to be moved to a position in proximity or in contact with a first abutting surface within the cavity; and
wherein upon movement of the second elongated member into a locking position within the first bore, the second ball bearing is caused to be moved to a position in proximity or in contact with a second abutting surface within the cavity.

20. The animal restraint system of claim 19 wherein the first abutting surface and the second abutting surface and located on a flange.
